(19) United States
(12) Patent Application Publication
(10) Pub. No.: US 2025/0020482 A1
(43) Pub. Date: Jan. 16, 2025

(54) METHOD AND APPARATUS FOR CREATING A DIGITAL MAP

(71) Applicant: Robert Bosch GmbH, Stuttgart (DE)

(72) Inventors: Muhammad Sheraz Khan, Heilbronn (DE); Philipp Ruchti, Aspach (DE); Carsten Hasberg, Ilsfeld-Auenstein (DE)

(21) Appl. No.: 18/758,087

(22) Filed: Jun. 28, 2024

(30) Foreign Application Priority Data
Jul. 10, 2023 (DE) 10 2023 206 518.5

(51) Int. Cl. G01C 21/00

(52) U.S. Cl. CPC G01C 21/3848

(57) ABSTRACT

A method and apparatus for creating a digital map. The method includes: receiving surrounding area data value sets, each set being detected using an environmental sensor system of a vehicle traveling along a traffic route, wherein each surrounding area data value set includes surrounding area features and a position of the surrounding area features; creating the digital map, wherein in the creating, the surrounding area features of the surrounding area data sets are sorted into groups depending on their position, a spatial arrangement of the respective surrounding area features relative to one another is determined for each group, an optimized position of the surrounding area features of the group is determined for each group without changing the spatial arrangement, and the digital map is created depending on the optimized position of the surrounding area features of each group; and providing the digital map.

### CROSS REFERENCE

The present application claims the benefit under 35 U.S.C. § 119 of German Patent Application No. 10 2023 206 518.5 filed on Jul. 10, 2023, which is expressly incorporated herein by reference in its entirety.

### FIELD

The present invention relates, inter alia, to a method for creating a digital map that represents at least one region along a traffic route, comprising a step of receiving a plurality of surrounding area data value sets, wherein each surrounding area data value set comprises surrounding area features; a step of creating the digital map depending on the surrounding area features; and a step of providing the digital map.

### SUMMARY

According to an example embodiment of the present invention, the method for creating a digital map that represents at least one region along a traffic route comprises a step of receiving a plurality of surrounding area data value sets, wherein each surrounding area data value set is detected by means of an environmental sensor system of a vehicle traveling along the traffic route, wherein each surrounding area data value set comprises surrounding area features and a position of said surrounding area features. The method further comprises a step of creating the digital map, wherein in a first sub-step, the surrounding area features of the surrounding area data sets are sorted into groups depending on their position, wherein in a second sub-step, a spatial arrangement of the respective surrounding area features relative to one another is determined for each group, wherein in a third sub-step, an optimized position of the surrounding area features of said group is determined for each group without changing the spatial arrangement, wherein in a fourth sub-step, the digital map is created depending on the optimized position of the surrounding area features of each group; and a step of providing the digital map.

A traffic route is, for example, a single-lane or multi-lane road. A region along a traffic route is understood to mean, for example, the traffic route itself along with a strip to the left and/or right of the traffic route. The width of the strip depends, for example, on the specific configuration of the surrounding area and/or the sensor range of the individual vehicles. As a rule, this strip comprises surrounding area features such as traffic signs, etc.

An environmental sensor system is understood to mean at least one video sensor and/or at least one radar sensor and/or at least one lidar sensor and/or at least one ultrasonic sensor and/or at least one further sensor that is designed to detect a surrounding area of a vehicle in the form of sensor data values. In one possible embodiment, the environmental sensor system comprises, for example, a computing unit (processor, working memory, hard drive) with suitable software and/or is connected to such a computing unit for this purpose.

A surrounding area feature is, for example, understood here to mean an infrastructure feature (roadway boundary lines, guardrails, etc.) and/or a traffic sign (road signs, traffic lights, etc.) and/or a structural feature (buildings, bridges, tunnels, etc.) and/or a further feature that can be detected by means of an environmental sensor system.

A digital map is understood to mean a map that is present in the form of (map) data values on a storage medium. For example, the map is designed to comprise one or more map layers, wherein one map layer, for example, shows a map from the bird's eye view (course and position of roads, buildings, landscape features, etc.). This corresponds to a map of a navigation system, for example. A further map layer comprises, for example, a radar map, wherein surrounding area features comprised by the radar map are stored along with a radar signature. A further map layer comprises, for example, a lidar map, wherein surrounding area features comprised by the lidar map are stored along with a lidar signature.

In one example embodiment of the present invention, the map is designed as a highly accurate map. The highly accurate map is in particular designed in such a way that it is suitable for the navigation of an automated vehicle. This is understood, for example, to mean that the highly accurate map is designed to determine a highly accurate position of the automated vehicle by comparing stored surrounding area features with detected sensor data values of this automated vehicle. For this purpose, the highly accurate map, for example, comprises these surrounding area features along with highly accurate position specifications (coordinates). In this context, a map is understood to mean a globally accurate map

A highly accurate position is understood to mean a position which is accurate within a specified coordinate system, e.g., WGS84 coordinates, in such a way that this position does not exceed a maximum permitted uncertainty. The maximum uncertainty may depend on the surrounding area, for example. Furthermore, the maximum uncertainty can depend, for example, on whether a vehicle is operated manually or in a partially, highly or fully automated manner (corresponding to one of SAE levels 1 to 5). In principle, the maximum uncertainty is so low that safe operation of the automated vehicle is in particular ensured. For a fully automated operation of the automated vehicle, the maximum uncertainty is, for example, in an order of magnitude of approximately 10 centimeters.

Creating the digital map is understood to mean, for example, that surrounding area features that are comprised by the surrounding area data values are newly integrated into a base map according to their (optimized) position and/or surrounding area features already comprised by the base map are removed or adapted accordingly. Here, a base map is understood to mean in particular a digital map (as described above).

The method mentioned here according to the present invention advantageously achieves the object of providing a method for creating a digital map. This object is achieved by means of the method according to the present invention in that the surrounding area features provided for this purpose are sorted into groups depending on their position and a spatial arrangement of the respective surrounding area features in relation to one another is determined for each group. Subsequently, for each group, an optimized position of the surrounding area features of this group is determined without changing the relative spatial arrangement. This shows the advantage that, due to the plurality of surrounding area data value sets, individual errors or deviations in the positions of the surrounding area features, which can occur in satellite-based positioning systems, for example due to multipath effects or atmospheric disturbances, can be compensated for and optimized positions can be determined without changing the relative positions of said surrounding area features with respect to each other.

According to an example embodiment of the present invention, preferably, the spatial arrangement of the respective surrounding area features of a group comprises distances and/or angles between said surrounding area features.

According to an example embodiment of the present invention, preferably, for each surrounding area feature, the position of the corresponding surrounding area feature is determined from a combination of a vehicle position of the vehicle that detects said surrounding area feature and a relative position of said surrounding area feature with respect to this vehicle and is assigned to said surrounding area feature. The vehicle position of the vehicle is determined by means of a satellite-based positioning system for said vehicle and the relative position is determined from the corresponding surrounding area data set.

A position of the environmental feature is, for example, understood to mean a 3D specification in a specified coordinate system, e.g., WGS84 coordinates.

A combination of the vehicle position and the relative position of a surrounding area feature is understood to mean, for example, a vector addition of the coordinates of the vehicle position and the direction vector between this position and the position of the surrounding area feature.

According to an example embodiment of the present invention, preferably, the digital map is provided in such a way that the digital map can be requested and/or received by a vehicle, in particular an automated vehicle.

A vehicle is, for example, understood to mean a manually operated vehicle (SAE level 0) or an automated vehicle in accordance with one of SAE levels 1 to 5 (see SAE J3016 standard).

Operating the vehicle means, for example, performing lateral and/or longitudinal control (depending on the SAE level or the design of the [automated] vehicle). In one possible embodiment, the operation also comprises, for example, the execution of safety-related functions (“arming” an airbag, fastening seat belts, etc.) and/or other (driver assistance) functions.

According to an example embodiment of the present invention, the apparatus, in particular a computing unit, is configured to perform all steps of the method for creating a digital map. A computing unit means, for example, a server or a server network or a cloud.

According to an example embodiment of the present invention, the apparatus or computing unit comprises a processor, working memory, storage medium, and suitable software in order to perform the method according to the present invention. Furthermore, the apparatus comprises an interface in order to transmit and receive data values by means of a wired and/or wireless connection, for example with corresponding devices of vehicles (control units, communication devices, environmental sensor system, navigation system, etc.) and/or further off-board devices (server, cloud, etc.).

Furthermore, a computer program is provided according to the present invention, comprising commands that, when the computer program is executed by a computer, cause the computer to carry out a method according to the present invention. In one embodiment, the computer program corresponds to the software comprised by the second apparatus.

Furthermore, a machine-readable storage medium on which the computer program is stored is provided according to the present invention.

Advantageous developments of the present invention are disclosed herein.

### BRIEF DESCRIPTION OF THE DRAWING

Exemplary embodiments of the present invention are shown in the figures and explained in more detail in the following description.

FIG. 1 shows an exemplary embodiment of the method according to the present invention for creating a digital map in the form of a flow chart.

### DETAILED DESCRIPTION OF EXAMPLE EMBODIMENTS

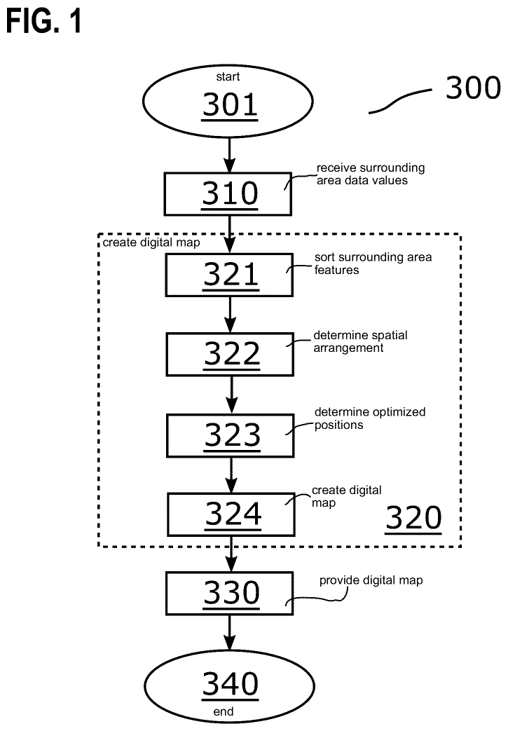

FIG. 1 shows an exemplary embodiment of a method 300 for creating 320 a digital map that represents at least one region along a traffic route.

In step 301, the method 300 starts.

In step 310, a plurality of surrounding area data value sets are received, wherein each surrounding area data value set is detected by means of an environmental sensor system of a vehicle traveling on the traffic route, wherein each surrounding area data value set comprises surrounding area features and a position of said surrounding area features.

In step 320, the digital map is created, which step comprises the four sub-steps 321-324.

In the first sub-step 321, the surrounding area features of the surrounding area data sets are sorted into groups depending on their position. Surrounding area features that are within a certain proximity according to predefined criteria (e.g. a maximum distance from each other) are grouped together.

In the second sub-step 322, a spatial arrangement of the respective surrounding area features relative to one another is determined for each group.

In the third sub-step 323, for each group, an optimized position of the surrounding area features of said group is determined without changing the relative spatial arrangement. For each group, optimized positions are determined from the plurality of individual positions of all surrounding area features taken into account. The relative spatial arrangement of the surrounding area features of a group remains unchanged.

In the fourth sub-step 324, the digital map is created depending on the optimized position of the surrounding area features of each group.

In step 330, the digital map is provided.

In step 340, the method 300 ends.

What is claimed is:

1. A method for creating a digital map that represents at least one region along a traffic route, the method comprising the following steps:
receiving a plurality of surrounding area data value sets, wherein each surrounding area data value set is detected using an environmental sensor system of a vehicle traveling along the traffic route, wherein each surrounding area data value set includes surrounding area features and a position of the surrounding area features;
creating the digital map, wherein in a first sub-step, the surrounding area features of the surrounding area data sets are sorted into groups depending on their position, wherein in a second sub-step, a spatial arrangement of the respective surrounding area features relative to one another is determined for each group, wherein in a third sub-step, an optimized position of the surrounding area features of each group is determined for each group without changing the spatial arrangement, and wherein in a fourth sub-step, the digital map is created depending on the optimized position of the surrounding area features of each group; and
providing the digital map.

2. The method according to claim 1, wherein the spatial arrangement of the respective surrounding area features of each group includes distances and/or angles between the respective surrounding area features.

3. The method according to claim 1, wherein, for each surrounding area feature, the position of the surrounding area feature is determined from a combination of a vehicle position of the vehicle that detects the surrounding area feature, wherein the vehicle position is determined using a satellite-based positioning system for the vehicle, and a relative position of the surrounding area feature to the vehicle, wherein the relative position is determined from the surrounding area data value set and is assigned to the surrounding area feature.

4. The method according to claim 1, wherein the providing of the digital map is carried out in such a way that the digital map can be requested and/or received by a vehicle including an automated vehicle.

5. An apparatus, comprising:
a computing unit configured to create a digital map that represents at least one region along a traffic route, the computing unit configured to:
receive a plurality of surrounding area data value sets, wherein each surrounding area data value set is detected using an environmental sensor system of a vehicle traveling along the traffic route, wherein each surrounding area data value set includes surrounding area features and a position of the surrounding area features;
create the digital map, including, in a first sub-step, the surrounding area features of the surrounding area data sets are sorted into groups depending on their position, in a second sub-step, a spatial arrangement of the respective surrounding area features relative to one another is determined for each group, in a third sub-step, an optimized position of the surrounding area features of each group is determined for each group without changing the spatial arrangement, and in a fourth sub-step, the digital map is created depending on the optimized position of the surrounding area features of each group; and
provide the digital map.

6. A non-transitory machine-readable storage medium on which is stored a computer program for creating a digital map that represents at least one region along a traffic route, the computer program, when executed by a computer, causing the computer to perform the following steps:
receiving a plurality of surrounding area data value sets, wherein each surrounding area data value set is detected using an environmental sensor system of a vehicle traveling along the traffic route, wherein each surrounding area data value set includes surrounding area features and a position of the surrounding area features;
creating the digital map, wherein in a first sub-step, the surrounding area features of the surrounding area data sets are sorted into groups depending on their position, wherein in a second sub-step, a spatial arrangement of the respective surrounding area features relative to one another is determined for each group, wherein in a third sub-step, an optimized position of the surrounding area features of each group is determined for each group without changing the spatial arrangement, and wherein in a fourth sub-step, the digital map is created depending on the optimized position of the surrounding area features of each group; and
providing the digital map.
